(19) United States
(12) Patent Application Publication
(10) Pub. No.: US 2026/0159737 A1
(43) Pub. Date: Jun. 11, 2026

(54) REFRIGERANT COMPOSITION FOR AIR CONDITIONING DEVICE

(71) Applicants: YM LEMY CORPORATION, Daegu (KR); KOREA INSTITUTE OF MACHINERY & MATERIALS, Daejeon (KR)

(72) Inventors: Gum Bae CHOI, Daejeon (KR); Chan Wook PARK, Daegu (KR); Jin Woo YOO, Daejeon (KR); Dong Ho KIM, Sejong (KR); Kong Hoon LEE, Daejeon (KR)

(73) Assignees: YM LEMY CORPORATION, Daegu (KR); KOREA INSTITUTE OF MACHINERY & MATERIALS, Daejeon (KR)

(21) Appl. No.: 18/717,430

(22) PCT Filed: Nov. 24, 2022
(86) PCT No.: PCT/KR2022/018661

§ 371 Date: Jun. 7, 2024

(30) Foreign Application Priority Data
Dec. 7, 2021 (KR) 10-2021-0174076

(51) Int. Cl. C09K 5/04

(52) U.S. Cl. CPC C09K 5/044; C09K 2205/122; C09K 2205/126; C09K 2205/22

(57) ABSTRACT

The present invention relates to a refrigerant composition for an air conditioning device, the refrigerant composition having characteristics similar to those of R410A, having a sufficiently low GWP, and comprising trifluoroethene and trifluoroiodomethane.

### TECHNICAL FIELD

The present invention relates to a refrigerant composition for an air conditioning device, and more particularly, to a refrigerant composition for an air conditioner device, including trifluoroethene and trifluoroiodomethane.

### BACKGROUND ART

As a refrigerant for air conditioning devices such as air conditioners (hereinafter referred to as “air conditioning device”), R410A, R1234yf, and the like are currently used. R410A is a two-component mixed refrigerant of difluoromethane (CH₂F₂; HFC-32 or R32) and pentafluoroethane (C₂HF₅; HFC-125 or R125), and it is a near azeotropic composition.

However, since the global warming coefficient (GWP) of R410A is 2088 and concerns about global warming increase, R32 with a GWP of 675 is being used more. For this reason, a low-GWP mixed refrigerant capable of replacing R410A is required.

### DETAILED DESCRIPTION OF THE INVENTION

### Technical Problem

The present invention has been proposed to solve the problems of the prior art as described above, and an object of the present invention is to provide a refrigerant composition that has cooling capacity (sometimes referred to as ‘capacity’) equivalent to R410A and superior to R1234yf, a sufficiently small GWP, the safety of lower flammability (class A2L), and the general characteristics required for refrigerants and that may allow the conventional air conditioning devices to be used as they are or after being slightly modified.

### Technical Solution

To achieve the above object, the present invention provides a refrigerant composition for an air conditioning device, including trifluoroethene and trifluoroiodomethane.

In the above, trifluoroethene is 65% to 75% by weight, and trifluoroiodomethane is 25% to 35% by weight.

In the above, trifluoroethene is 70% by weight, and trifluoroiodomethane is 30% by weight.

### Advantageous Effects

A refrigerant composition for an air conditioning device according to the present invention has cooling capacity equivalent to R410A and superior to R1234yf, a sufficiently small GWP, the safety of lower flammability (class A2L) according to the American Society of Heating, Refrigerating and Air-Conditioning Engineers (ASHRAE) standards, an ozone depletion potential (ODP) of 0, and an effect of allowing to replace air conditioning devices used for R410A and R1234yf without modification or change thereof.

### DESCRIPTION OF THE DRAWINGS

FIG. 1 shows a graph illustrating the saturated vapor pressure at each mixing ratio.

FIG. 2 shows a graph illustrating the boiling point at each mixing ratio.

FIG. 3 shows a graph illustrating the volumetric capacity at 0° C. at each mixing ratio.

FIG. 4 shows a graph illustrating the volumetric capacity at −30° C. at each mixing ratio.

FIG. 5 shows a graph illustrating the heat of combustion at each mixing ratio.

### BEST MODE

All technical terms and scientific terms used in the description of the present invention have meanings commonly understood by those of ordinary skill in the art to which the present disclosure belongs, unless otherwise defined. All terms used in the present disclosure are selected for the purpose of more clearly describing the present disclosure and are not selected to limit the scope of rights according to the present disclosure.

Expressions such as “comprising,” “including,” “having,” and the like used in the description of the present invention should be understood as open-ended terms implying the possibility of including other embodiments, unless otherwise stated in the phrase or sentence in which the expression is included.

Singular expressions used in the description of the present invention may include the meaning of a plural form unless otherwise stated, and this applies to the singular expressions described in the claims as well.

Expressions such as “first” and “second” used in the description of the present invention are used to distinguish a plurality of components from each other, and do not limit the order or importance of the components.

In the description of the present invention, when an element is referred to as being “connected” or “coupled” to another element, it should be understood that an element may be directly connected to or coupled with another element, or that they may be connected or coupled with a new and different element as a mediator.

### Summary of Terminology

In the present specification, when the term “replacement” is used in the context of “replacing” a first refrigerant with a second refrigerant, as a first type, it means that a device that is designed to be operated using a first refrigerant may be operated using a second refrigerant under optimal conditions simply by undergoing a slight change of the components (at least one of refrigerating machine oil, gasket, packing, expansion valve, dryer, and other components) or device adjustment according to the need.

Aspects of this type of “replacement” include “drop-in replacement,” “nearly drop-in replacement,” and “retrofitting” in an ascending order of the degree of change or adjustment required at the time of replacement with a second refrigerant.

As a second type, the term “replacement” also includes mounting a second refrigerant for the same use as the existing use of a first refrigerant on a device that is designed to be operated using the second refrigerant. This type refers to replacing with a refrigerant and providing it for the same application.

Hereinafter, the refrigerant composition for an air conditioning device according to the present invention will be described in detail with reference to the accompanying drawings.

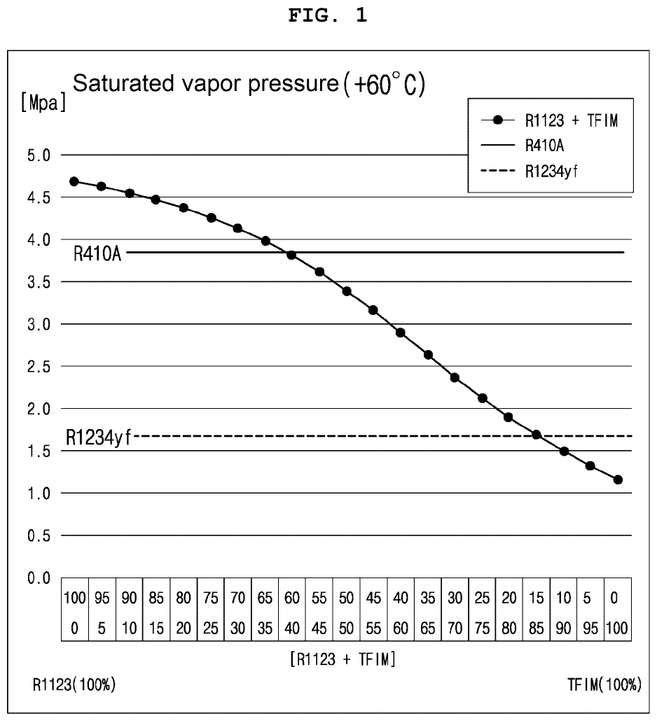

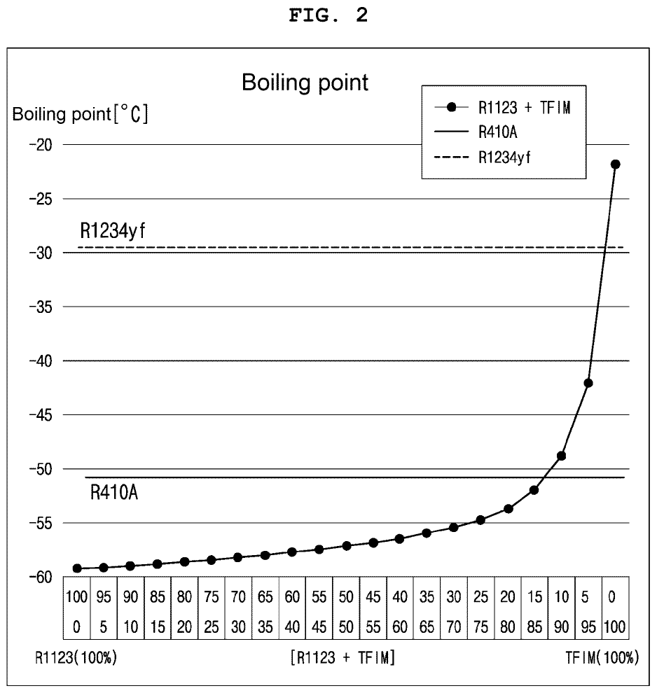

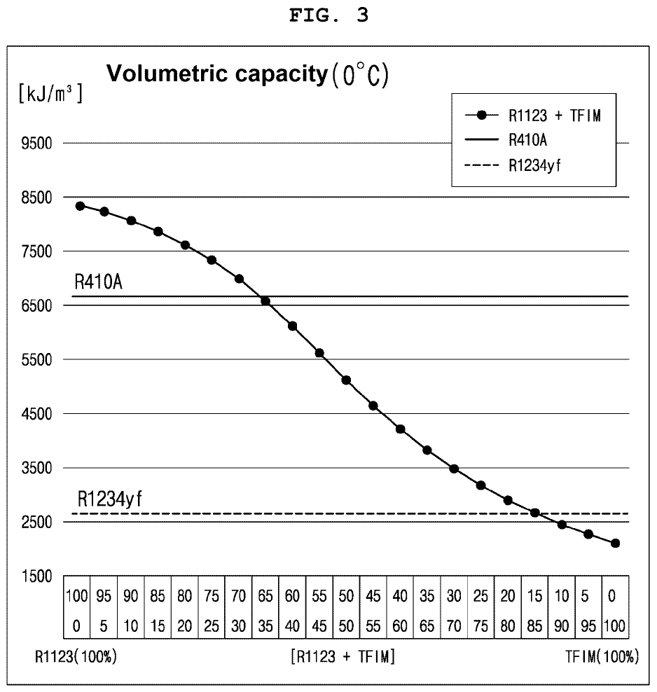

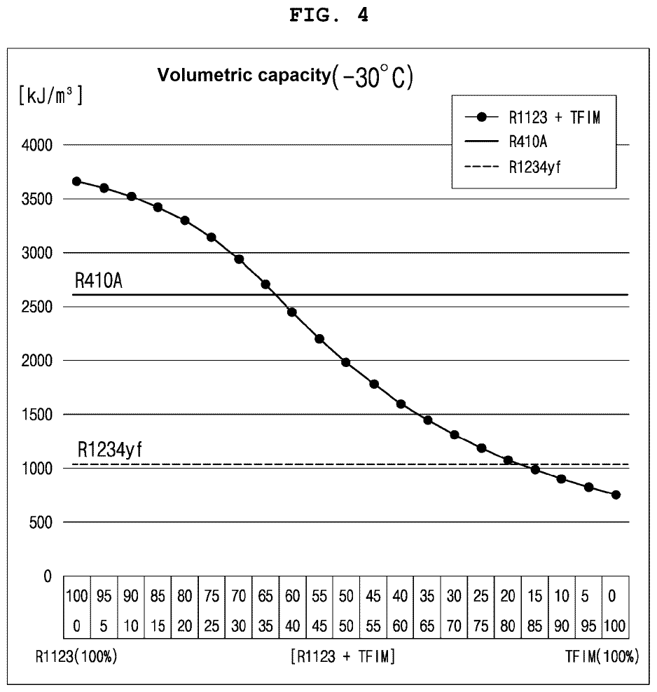

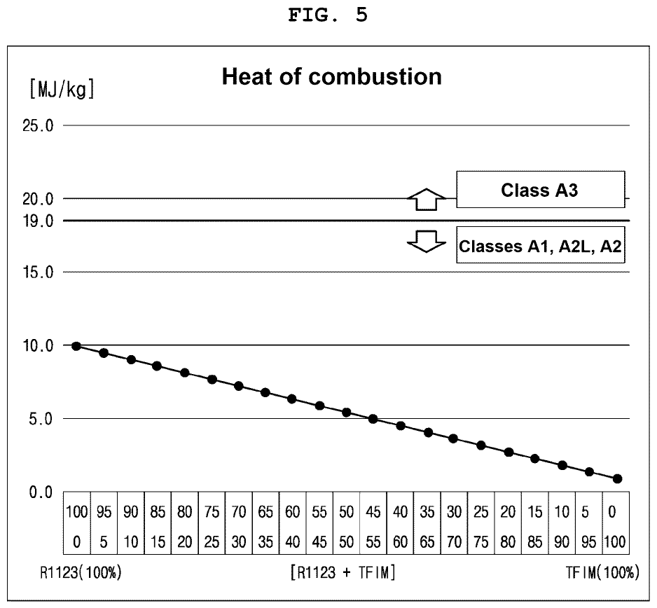

FIG. 1 shows a graph illustrating the saturated vapor pressure at each mixing ratio; FIG. 2 shows a graph illustrating the boiling point at each mixing ratio; FIG. 3 shows a graph illustrating the volumetric capacity at 0° C. at each mixing ratio; FIG. 4 shows a graph illustrating the volumetric capacity at −30° C. at each mixing ratio; and FIG. 5 shows a graph illustrating the heat of combustion at each mixing ratio.

The refrigerant composition of the present invention includes trifluoroethene (C₂F₃H or R1123) and trifluoroiodomethane (TFIM; CF₃I or R13I1).

The refrigerant composition of the present invention contains trifluoroethene (R1123) in the range of 65% to 75% by weight and trifluoroiodomethane (R13I1) in the range of 25% to 35% by weight. The refrigerant composition preferably contains 70% by 5 weight of trifluoroethene (R1123) and 30% by weight of trifluoroiodomethane (R13I1). A refrigerant including the refrigerant composition of the present invention may further include an additive such as a lubricant in the refrigerant composition according to the present invention.

Table 1 below shows the physical properties of each of the trifluoroethene (R1123) and trifluoroiodomethane (R13I1).

TABLE 1

| | Trifluoroethene | Trifluoroiodomethane |
|---|---|---|
| | (R1123) | (R13I1) |
| Molecular | 82 | 195.9 |
| Weight (g/mol) | | |
| Boiling point | −59.1 | −21.9 |
| (° C.) | | |
| Vapor pressure | 4.7 | 1.2 |
| (@60° C., MPa) | | |
| LFL (vol %) | 10 | — |
| Combustion | 9.9 | 0.9 |
| heat (MJ/kg) | | |
| Burning speed | 6.6 | — |
| (cm/s) | | |
| Flammability | A2L | A1 |
| class | | |
| Warming | 1 | 1 |
| Potential | | |
| (GWP) | | |
| Ozone | 0 | 0 |
| Depletion | | |
| Potential | | |
| (ODP) | | |

### (LFL: Lower Flammability Limit)

Hereinafter, the refrigerant composition of the present invention will be described in more detail with examples of the present invention, but these examples are only examples of the present invention, and the scope of the present invention is not limited to the examples.

In the refrigerant composition according to the present invention, a refrigerant composition consisting of 70% by weight of trifluoroethene (R1123) and 30% by weight of trifluoroiodomethane (R13I1) (hereinafter referred to as “examples of the refrigerant composition of the present invention”) is explained in comparison with R410A and R1234yf.

In the refrigerant composition consisting of trifluoroethene (R1123) and trifluoroiodomethane (R1311), the properties of the composition are unchanged even when they are mixed in a certain ratio, and the composition maintains eco-friendly characteristics as a near azeotropic composition that compensates for each other's defects.

The boiling point, saturated vapor pressure, flammability class, GWP, and ODP values of the refrigerant composition of the Example of the present invention were compared with those of R410A and R1234yf, and the results are shown in Table 2 below.

TABLE 2

| | R410A | R1234yf | Example |
|---|---|---|---|
| Molecular Weight | 72.6 | 114 | 102 |
| (g/mol) | | | |
| Boiling point (° C.) | −51.4 | −29.5 | −58 |
| Saturated vapor | 3.8 | 1.6 | 4.1 |
| pressure (@60° C., | | | |
| MPa) | | | |
| Flammability | A1 | A2L | A2L |
| rating | | | |
| Warming Potential | 2088 | 4 | One |
| (GWP) | | | |
| Ozone Depletion | 0 | 0 | 0 |
| Potential (ODP) | | | |

Referring to the saturated vapor pressure graph at 60° C. shown in FIG. 1, the saturated vapor pressure of the refrigerant composition of the Example of the present invention is 4.1 MPa, that of R410A is 3.8 MPa, and that of R1234yf is 1.6 MPa. Therefore, it can be seen that the saturated vapor pressure of the Example is higher than that of R410A by about 8% and higher than that of R1234yf by 56%.

Referring to the boiling point graph shown in FIG. 2, the boiling point of the refrigerant composition of the Example of the present invention is −58° C., that of R410A is −51.4° C., and that of R1234yf is −29.5° C. It can be seen that the boiling point of the ‘Example’ is lower than that of R410A by 6.6° C. and lower than that of R1234yf by 28.5° C.

The safety of the refrigerant composition of the Example of the present invention is described.

According to Refrigerants Safety Classification (ISO 817), A2 and A3 classes are differentiated based on the case where there is no toxicity and the heat of combustion is 19 MJ/kg. As shown in the heat of combustion graph illustrated in FIG. 5, the heat of combustion of the refrigerant composition of the Example of the present invention is 7.2 MJ/kg, so the classis A2 or lower.

In addition, according to ASHRE A34, the criterion for A2L is a burning velocity of 10 cm/s or less. As shown in Table 1, since the burning velocity of R1123 (100%) is 6.6 cm/s and the burning velocity of R1311 (100%) is A1, the burning velocity of the refrigerant composition of the Example of the present invention is 10 cm/s or less, and the safety class is A2L.

As can be seen from the graphs illustrated in FIGS. 1 and 2 and from Table 2, the refrigerant composition of the refrigerant composition of the Example of the present invention has characteristics that allow it to be used as a refrigerant, GWP of 1, which is significantly lower than that of R410A and R1234yf, and ODP of 0, which indicates that the composition is eco-friendly.

Hereinafter, to examine whether the refrigerant composition of the present invention [R1123 (70 wt %)+R13I1 (30 wt %)] may be immediately applied as a replacement under the operational conditions of devices in which R410A and R1234yf are used, an experiment was performed on the theoretical cyclic characteristics such as condensation and evaporation pressure, compression ratio, discharge temperature, volumetric capacity, and coefficient of performance (COP) under cooling conditions (standard) (external air temperature: 36.5° C., internal air temperature: 26.7° C.), cooling conditions (extremely hot) (external air temperature: 46.1° C., internal air temperature: 26.7° C.), heating condition (standard) (external air temperature: 8.3° C., internal air temperature: 21.1° C.), heating condition (extremely cold) (external air temperature: −8.3° C., internal air temperature: 21.1° C.), heating condition (extremely cold 2) (external air temperature: −30.0° C., internal air temperature: 21.1° C.), and the results are shown in Tables 3 to 7 below.

TABLE 3
Test results of cycle characteristics in cooling conditions (standard)

| | | | Refrigerant composition |
|---|---|---|---|
| | | | of the present |
| | | | invention |
| | | | [R1123 (70 wt %) + |
| | R410A | R1234yf | R13I1 (30 wt %)] |
| Condensation | 45 | 45 | 45 |
| temperature (° C.) | | | |
| Condensation | 2726.1 | 1153 | 3024.8 |
| pressure (kPa) | | | |
| Evaporation | 6.7 | 6.7 | 6.7 |
| temperature (° C.) | | | |
| Evaporation | 982.8 | 394 | 1163.8 |
| pressure (kPa) | | | |
| Compression ratio | 2.77 | 2.93 | 2.6 |
| Discharge | 75.5 | 54.1 | 66.8 |
| temperature (° C.) | | | |
| Volumetric capacity | 5942 | 2504 | 5825 |
| (kJ/m³) | | | |
| Coefficient of | 4 | 4.18 | 3.67 |
| Performance (COP) | | | |

TABLE 4
Test results of cycle characteristics
in cooling conditions (extremely hot)

| | | | Refrigerant composition |
|---|---|---|---|
| | | | of the present |
| | | | invention |
| | | | [R1123 (70 wt %) + |
| | R410A | R1234yf | R13I1 (30 wt %)] |
| Condensation | 56.1 | 56.1 | 56.1 |
| temperature (° C.) | | | |
| Condensation | 3516.7 | 1502 | 3849.6 |
| pressure (kPa) | | | |
| Evaporation | 6.7 | 6.7 | 6.7 |
| temperature (° C.) | | | |
| Evaporation | 982.8 | 394 | 1163.8 |
| pressure (kPa) | | | |
| Compression ratio | 3.58 | 3.81 | 3.31 |
| Discharge | 92.7 | 65.7 | 81.8 |
| temperature (° C.) | | | |
| Volumetric capacity | 5169 | 2151 | 4759 |
| (kJ/m³) | | | |
| Coefficient of | 2.77 | 2.91 | 2.4 |
| Performance (COP) | | | |

TABLE 5
Test results of cycle characteristics in heating conditions (standard)

| | | | Refrigerant composition |
|---|---|---|---|
| | | | of the present |
| | | | invention |
| | | | [R1123 (70 wt %) + |
| | R410A | R1234yf | R13I1 (30 wt %)] |
| Condensation | 51.1 | 51.1 | 51.1 |
| temperature (° C.) | | | |
| Condensation | 3141.1 | 1336.8 | 3458.1 |
| pressure (kPa) | | | |
| Evaporation | −1.7 | −1.7 | −1.7 |
| temperature (° C.) | | | |
| Evaporation | 755.7 | 298 | 910 |
| pressure (kPa) | | | |
| Compression ratio | 4.2 | 4.49 | 3.8 |
| Discharge | 92 | 61.8 | 79.3 |
| temperature (° C.) | | | |
| Volumetric capacity | 5791 | 2307 | 5705 |
| (kJ/m³) | | | |
| Coefficient of | 3.56 | 3.64 | 3.26 |
| Performance (COP) | | | |

TABLE 6
Test results of cycle characteristics
in heating conditions (extremely cold)

| | | | Refrigerant composition |
|---|---|---|---|
| | | | of the present |
| | | | invention |
| | | | [R1123 (70 wt %) + |
| | R410A | R1234yf | R13I1 (30 wt %)] |
| Condensation | 51.1 | 51.1 | |
| temperature (° C.) | | | |
| Condensation | 3141.1 | 1336.8 | 3458.1 |
| pressure (kPa) | | | |
| Evaporation | −18.3 | −18.3 | −18.3 |
| temperature (° C.) | | | |
| Evaporation | 425.5 | 161.5 | 529.5 |
| pressure (kPa) | | | |
| Compression ratio | 7.4 | 8.28 | 6.5 |
| Discharge | 108.2 | 65.6 | 89.2 |
| temperature (° C.) | | | |
| Volumetric capacity | 3607 | 1326 | 3619 |
| (kJ/m³) | | | |
| Coefficient of | 2.68 | 2.67 | 2.44 |
| Performance (COP) | | | |

TABLE 7
Test results of cycle characteristics in
heating conditions (extremely cold 2)

| | | | Refrigerant composition |
|---|---|---|---|
| | | | of the present |
| | | | invention |
| | | | [R1123 (70 wt %) + |
| | R410A | R1234yf | R13I1 (30 wt %)] |
| Condensation | 41.1 | 41.1 | 41.1 |
| temperature (° C.) | | | |
| Condensation | 2483.9 | 1047.1 | 2771 |
| pressure (kPa) | | | |
| Evaporation | −40 | −40 | −40 |
| temperature (° C.) | | | |
| Evaporation | 174.9 | 62.4 | 225.3 |
| pressure (kPa) | | | |
| Compression ratio | 14.2 | 16.79 | 12.3 |
| Discharge | 120.4 | 63.7 | 94.1 |
| temperature (° C.) | | | |
| Volumetric capacity | 1805 | 608 | 1907 |
| (kJ/m³) | | | |
| Coefficient of | 2.3 | 2.25 | 2.13 |
| Performance (COP) | | | |

The refrigerant composition of the present invention [R1123 (70 wt %)+R13I1 (30 wt %)] has similar condensation pressure and evaporation pressure when compared to R410A, and as can be confirmed in the graphs shown in FIGS. 3 and 4, the volumetric capacity is also very similar.

In addition, there is advantage in eco-friendliness because the GWP is significantly low as 1 (the GWP of R410A is 2088) compared to R410A, and the ODP is 0, and there is also the advantage that the discharge temperature is lower than that of R410A.

Therefore, the refrigerant composition, which is an embodiment of the present invention, can be used as a substituting material for R410A, can be applied as it is to an existing R410A system in an eco-friendly manner, and is applicable to a variable refrigerant flow (VRF) of home appliances.

In addition, the refrigerant composition is applicable to all internal combustion engine cooling-only vehicles using R1234yf or R134a. In particular, the refrigerant composition has much better heating ability than R1234yf, which is used in electric vehicles, so it is possible to increase the mileage of electric vehicles in winter. In addition, the refrigerant composition has the advantage that it can be easily prepared as a two-component mixed refrigerant.

### INDUSTRIAL APPLICABILITY

A refrigerant composition for an air conditioning device according to the present invention has excellent cooling capacity, a sufficiently small GWP, lower flammability (A2L class) according to the ASHRAE standards, and an ODP of 0, and it may be simply prepared and substituted in air conditioning devices used for R410A and R1234yf without modification or change thereof.

1. A refrigerant composition for an air conditioning device, comprising trifluoroethene (R1123) and trifluoroiodomethane (R1311).

2. The refrigerant composition for an air conditioning device according to claim 1, wherein the trifluoroethane (R1123) is 65% to 75% by weight, and the trifluoroiodomethane (R1311) is 25% to 35% by weight.

3. The refrigerant composition for an air conditioning device according to claim 1, wherein the trifluoroethane (R1123) is 70% by weight, and the trifluoroiodomethane (R1311) is 30% by weight.
